(19) United States
(12) Patent Application Publication
(10) Pub. No.: US 2015/0217546 A1
(43) Pub. Date: Aug. 6, 2015

(54) SURFACE PROTECTIVE SHEET SUBSTRATE AND SURFACE PROTECTIVE SHEET

(71) Applicant: NITTO DENKO CORPORATION, Osaka (JP)

(72) Inventors: Takeshi IGARASHI, Osaka (JP); Yasunori YAMAMOTO, Osaka (JP); Nao WAKAYAMA, Osaka (JP)

(73) Assignee: NITTO DENKO CORPORATION, Osaka (JP)

(21) Appl. No.: 14/611,558

(22) Filed: Feb. 2, 2015

(30) Foreign Application Priority Data
Feb. 5, 2014 (JP) 2014-020729

(51) Int. Cl. B32B 27/32; B32B 27/08

(52) U.S. Cl. CPC B32B 27/32; B32B 27/08; B32B 2307/712

(57) ABSTRACT

Provided is a surface protective sheet substrate capable of bringing about weatherability with less weathering stabilizer. The surface protective sheet substrate provided by this invention comprises a polyolefin resin accounting for more than 50% by weight of the entire substrate. The substrate comprises an inorganic weathering stabilizer-containing layer which comprises an inorganic weathering stabilizer. The inorganic weathering stabilizer-containing layer has a thickness of 10 μm or larger, but smaller than 40 μm. The inorganic weathering stabilizer content accounts for 8% by weight or more of the inorganic weathering stabilizer-containing layer. The inorganic weathering stabilizer content per unit area of substrate is 2.0 g/m² or greater.

### CROSS-REFERENCE

The present application claims priority based on Japanese Patent Application No. 2014-020729 filed on Feb. 5, 2014, and the entire content thereof is incorporated herein by reference.

### BACKGROUND OF THE INVENTION

1. Field of the Invention

The present invention relates to a surface protective sheet and its substrate.

2. Description of the Related Art

During processing or transporting metal plates, painted steel plates, or synthetic resin plates, etc., as a known means to prevent their surfaces from receiving damages such as scratches, dirt deposits, etc., protective sheets are adhered to the surfaces. In general, such a surface protective sheet is temporarily adhered to an adherend while the adherend needs to be protected (e.g., during the process or transport, etc.). Subsequently, after use as a protective means, the surface protective sheet is removed from the adherend. A surface protective sheet used for such a purpose is generally constructed to comprise a pressure-sensitive adhesive (PSA) on a face of a resin substrate sheet (support substrate) so that it can serve the protection purpose when adhered via the PSA to an adherend (article to be protected). Examples of technical literature related to paint surface protective sheets which, for use, are adhered to protect paint surfaces include Japanese Patent Application Publication Nos. 2013-126743, 2010-138314, and 2011-111552.

### SUMMARY OF THE INVENTION

Such a surface protective sheet may be used in an embodiment where it is left for a long time in an environment exposed to high temperatures and ultraviolet (UV) rays, such as in the outdoors in summer, etc. Resistance to degradation caused by heat and UV rays (or weatherability hereinafter) is required from a surface protective sheet that is expected for use in such an embodiment. This is because upon degradation of the substrate or PSA constituting the surface protective sheet, in peeling and removing the surface protective sheet from the adherend surface, troubles are likely to occur, such as the presence of PSA residue (adhesion marks) left on the adherend surface, reduced removal efficiency because of weakening of the substrate and the occurrence of breakage of the surface protective sheet. In a known technique for providing weatherability to surface protective sheets, the surface protective sheet-constituting substrates (or simply “substrates” hereinafter) are supplemented with various weathering stabilizers including inorganic weathering stabilizers such as titanium oxides, etc., organic weathering stabilizers such as hindered amine-based stabilizers, etc., and the like.

In general, a greater effect tends to be obtained when a larger amount of weathering stabilizer is added. However, for instance, excessive addition of an inorganic weathering stabilizer may reduce the ease of substrate molding or hinder the weight reduction of the substrates (and thus surface protective sheets comprising the substrates). With respect to excessive addition of an organic weathering stabilizer, there has been a concern that the weathering stabilizer might transfer from the substrate to the PSA layer to contaminate the protected adherend.

An objective of the present invention is thus to provide a substrate for use in a surface protective sheet, with which undesirable effects of the added weathering stabilizer can be reduced while desirable weatherability is effectively obtained. Another objective of the present invention is to provide a surface protective sheet comprising such a surface protective sheet substrate.

### Solution to Problem

The surface protective sheet substrate disclosed herein is a resin film comprising a polyolefin resin which accounts for more than 50% by weight of the entire substrate. The substrate comprises an inorganic weathering stabilizer-containing layer which comprises an inorganic weathering stabilizer. The inorganic weathering stabilizer-containing layer has a thickness of 10 μm or larger, but smaller than 40 μm. The inorganic weathering stabilizer content accounts for 8% by weight or more of the inorganic weathering stabilizer-containing layer. The inorganic weathering stabilizer content per unit area of substrate is 2.0 g/m² or greater. A surface protective sheet substrate having such a constitution may allow lessening the undesirable effects such as a reduction in ease of substrate molding and hindrance in weight reduction of the substrates, etc., yet may achieve excellent weatherability.

In a preferable embodiment of the surface protective sheet substrate disclosed herein, the inorganic weathering stabilizer comprises a titanium oxide. With such a surface protective sheet substrate, there can be exhibited an effect to bring about lessening of undesirable effects caused by the inorganic weathering stabilizer as well as high weatherability.

In a preferable embodiment of the surface protective sheet substrate disclosed herein, the inorganic weathering stabilizer content accounts for 9% by weight or less of the entire substrate. Such a surface protective sheet substrate and a surface protective sheet comprising the substrate may be advantageous from the standpoint of weight reduction, cost reduction, easier molding, etc.

In a preferable embodiment of the surface protective sheet substrate disclosed herein, the substrate further comprises a layer A that is a resin layer constituting a first surface of the substrate and is essentially free of an inorganic weathering stabilizer. A surface protective sheet substrate having such a constitution may exhibit excellent weatherability when used in an embodiment of a surface protective sheet comprising a PSA layer preferably on the layer A-side surface.

In a preferable embodiment of the surface protective sheet substrate disclosed herein, the substrate comprises an organic weathering stabilizer at 0.25% by weight or less of the entire substrate. The layer A is preferably an organic weathering stabilizer-free layer which is essentially free of the organic weathering stabilizer. When used in an embodiment of a surface protective sheet comprising a PSA layer preferably on the layer A-side surface, a surface protective sheet substrate having such a constitution may have a low potential for contamination of an adherend subject to surface protection.

The surface protective sheet substrate disclosed herein may further comprises, for instance, a layer B that is a resin layer constituting the second surface of the substrate and is essentially free of an inorganic weathering stabilizer. In a surface protective sheet substrate having such a constitution, there can be exhibited an effect to bring about lessening of undesirable effects caused by the inorganic weathering stabilizer as well as high weatherability.

In a preferable embodiment of the surface protective sheet substrate disclosed herein, the layer B is an organic weathering stabilizer-free layer which is essentially free of the organic weathering stabilizer. For instance, when a surface protective sheet substrate having such a constitution is in a form of a surface protective sheet that comprises a PSA layer on the layer A-side surface and is wound in a roll with the PSA layer being in contact with the layer B and when the surface protective sheet is used in an embodiment where it is unwound from the roll to be adhered to an adherend, the substrate may have a low potential for contamination of the adherend.

In a preferable embodiment of the surface protective sheet substrate disclosed herein, the substrate has an overall thickness smaller than 60 μm. A surface protective sheet using such a surface protective sheet substrate may be suitable for bringing about high weatherability, with it being a thin sheet itself.

The art disclosed herein provides a surface protective sheet comprising a surface protective sheet substrate and a PSA layer placed on a first surface of the surface protective sheet substrate. A surface protective sheet having such a constitution may exhibit high weatherability. Thus, for instance, the surface protective sheet may be preferably used for protecting an adherend that is expected to be stored outdoors for a prolonged period.

### BRIEF DESCRIPTION OF THE DRAWINGS

FIG. 1 shows a cross-sectional view schematically illustrating an embodiment of the surface protective sheet according to the present invention.

### DETAILED DESCRIPTION OF THE INVENTION

Preferred embodiments of the present invention are described below. Matters necessary to practice this invention other than those specifically referred to in this description may be understood as design matters based on the conventional art in the pertinent field for a person of ordinary skill in the art. The present invention can be practiced based on the contents disclosed in this description and common technical knowledge in the subject field.

The embodiment in the drawing is schematically illustrated for clearly describing the present invention, and does not represent the dimensions or scales of the surface protective sheet of the present invention that is actually provided as a product.

### [Resin Component]

The surface protective sheet substrate disclosed herein is constituted as a resin film comprising one, two or more resin layers. The resin film is typically non-porous. The term “non-porous resin film” referred to herein should be conceptually distinguished from the so-called non-woven fabric (i.e., meaning to exclude non-woven fabrics). Such resin film may be obtained, for instance, by molding into a form of film a resin composition comprising a resin component as a primary component.

Examples of the resin component constituting the resin film include polyolefin-based resins such as a polyethylene (PE) resin, polypropylene (PP) resin, ethylene-propylene copolymer resin, etc.; polyester-based resins such as a polyethylene terephthalate (PET) resin, etc.; vinyl chloride-based resins; vinyl acetate-based resins; polyimide-based resins; polyamide-based resins; fluorine-based resins; and the like.

When the substrate has a multi-layer structure comprising two or more resin layers, the resin components constituting the respective resin layers may have the same composition or different compositions. For instance, the substrate may comprise multiple resin layers having essentially the same resin composition with varied compositions of additives (inorganic weathering stabilizer, organic weathering stabilizer, etc.).

From the standpoint of preventing the surface protective sheet substrate (and thus a surface protective sheet comprising the substrate) from warping, etc., for instance, the surface protective sheet substrate can be made to have a constitution in which a layer constituting a first surface of the substrate and another layer constituting the second surface of the substrate have approximately the same resin composition with an intermediate layer placed between the two, with the intermediate layer consisting of one, two or more layers having different resin composition(s). In this case, it is preferable that the layer constituting the first surface of the substrate and the layer constituting the second surface of the substrate have approximately the same thickness.

As the surface protective sheet substrate in the art disclosed herein, a resin film comprising a polyolefin-based resin as a primary component (e.g. a component contained in the substrate, accounting for more than 50% by weight) can be preferably used. A substrate having such a composition is preferable also from the standpoint of recyclability, etc. For instance, as the polyolefin-based resin, a resin film comprising one or each of a PE resin and a PP resin can be preferably used. In other words, in the surface protective sheet substrate, the total amount of the PE resin and PP resin may exceed 50% by weight of the entire substrate.

The primary component of the PP resin can be a polymer (a propylene-based polymer) of various types that contains propylene as a constituent. It can be a PP resin consisting essentially of one, two or more species of propylene-based polymer. The concept of the propylene-based polymer referred to herein include, for instance, the following polypropylenes:

Propylene homopolymer (homopolypropylenes) such as isotactic polypropylenes.

Random copolymers (random polypropylenes) of propylene and other α-olefin(s) (typically, one, two or more species selected from ethylene and α-olefins having 4 to 10 carbons); preferably random polypropylenes constituted with propylene as the primary monomer (a main monomer, i.e., a component accounting for more than 50% by weight of all monomers); for instance, a random polypropylene obtained by random copolymerization of 96 to 99.9 mol % of propylene and 0.1 to 4 mol % of another α-olefin (preferably ethylene and/or butene).

Block copolymers (block polypropylenes) comprising a copolymer (preferably a copolymer wherein the primary monomer is propylene) obtained by block copolymerization of propylene and other α-olefin(s) (typically, one, two or more species selected from ethylene and α-olefins having 4 to 10 carbons), and typically, further comprising as a by-product of the block copolymerization a rubber formed of at least either one of propylene and the other α-olefin; for instance, a block polypropylene comprising a polymer obtained by block copolymerization of 90 to 99.9 mol % of propylene and 0.1 to 10 mol % of other α-olefin(s) (preferably ethylene and/or butene), and further comprising as a by-product a rubber formed of at least either one of propylene and the other α-olefin.

The PP resin can be formed essentially of one, two or more species of such propylene-based polymer, or can be a thermoplastic olefin resin (TPO) or a thermoplastic elastomer (TPE) of a reactor blend type obtainable by copolymerizing a propylene-based polymer with a large amount of a rubber component, or of a dry blend type obtainable by mechanically dispersing the rubber component in a propylene-based polymer. Alternatively, it can be a PP resin comprising a copolymer of propylene and a monomer (functional monomer) containing other functional group(s) in addition to a polymerizing functional group, a PP resin obtained by copolymerizing such a functional monomer with a propylene-based polymer, or the like.

The primary component of the PE resin can be a polymer (an ethylene-based polymer) of various types that contains ethylene as a constituent. It can be a PE resin consisting essentially of one, two or more species of ethylene-based polymer. The ethylene-based polymer can be an ethylene homopolymer or a product of copolymerization of ethylene as the primary monomer and other α-olefin(s) (e.g. an α-olefin having 3 to 10 carbons). Preferable examples of the α-olefin include propylene, 1-butene, 1-hexene, 4-methyl-1-pentene, 1-octene, and the like. It can be a PE resin comprising a copolymer of ethylene and a monomer (functional monomer) containing other functional group(s) in addition to a polymerizing functional group, a PE resin obtained by copolymerizing such a functional monomer with an ethylene-based polymer, or the like. Examples of a copolymer of ethylene and a functional monomer include ethylene-vinyl acetate copolymers (EVA), ethylene-acrylic acid copolymers (EAA), ethylene-methacrylic acid copolymers (EMAA), ethylene-methyl acrylate copolymers (EMA), ethylene-ethyl acrylate copolymers (EEA), ethylene-methyl methacrylate copolymers (EMMA), ethylene-(meth)acrylic acid (i.e., ethylene-acrylic acid, or ethylene-methacrylic acid) copolymers crosslinked by metal ions, and the like.

The density of the PE resin is not particularly limited, and it can be, for instance, about 0.9 g/cm³ to 0.94 g/cm³ (typically 0.91 g/cm³ to 0.93 g/cm³). Preferable PE resins include a low-density polyethylene (LDPE) and a linear low-density polyethylene (LLDPE). In the art disclosed herein, as the PE resin, an LLDPE can be preferably used.

As a preferable embodiment of the surface protective sheet substrate disclosed herein, can be cited a single-layer (one-layer) or multi-layer substrate whose resin component essentially consists of a PE resin and/or a PP resin. As for a multi-layer substrate, each layer constituting the substrate may be a layer whose resin component consists of a PE resin alone (a PE layer), a layer whose resin component consists of a PP resin alone (a PP layer), or a layer formed of a resin blend comprising a PE resin and a PP resin at an arbitrary ratio (a PE-PP layer). For instance, a multi-layer substrate comprising multiple (preferably two, three or four) PE-PP layers comprising a PE resin and a PP resin at varied blend ratios can be preferably used.

The resin material(s) constituting the resin component of the substrate can be selected so as to give rise to an appropriate melt mass-flow rate (MFR) in view of the substrate production (film formation) method and production conditions. If necessary, a blend of two or more different kinds of resin materials can be used. Although not particularly limited, for instance, a resin material having a MFR of approximately 0.5 g/10 min to 80 g/10 min can be used. Herein, the MFR refers to a value measured based on JIS K 7210 by method A at a temperature of 230° C. at an applied load of 21.18 N. From the standpoint of reducing the thermal contraction, a resin material having a MFR of about 0.5 g/10 min to 10 g/10 min can be preferably used. The resin material can be a PE resin or a PP resin having a MFR in this range, or a resin material formed of a PP resin and a PE resin blended to have a MFR in this range.

### [Inorganic Weathering Stabilizer]

The surface protective sheet substrate disclosed herein comprises an inorganic weathering stabilizer. The term inorganic weathering stabilizer herein refers to an inorganic material (typically an inorganic powder) capable of increasing the weatherability of the surface protective sheet substrate. Such an inorganic material may be perceived as an inorganic pigment (or colorant) or as a filler. The surface protective sheet substrate disclosed herein comprises at least one layer that comprises such an inorganic weathering stabilizer (or “inorganic weathering stabilizer-containing layer” or “layer W” hereinafter). The surface protective sheet substrate may comprise two or more layers W that are the same or different from one another. In a substrate comprising two or more different layers W, the layers W may differ, for instance, either in composition or thickness, or in both.

Preferable examples of inorganic weathering stabilizer include inorganic powders such as a titanium oxide (typically of the rutile type), zinc oxide, calcium carbonate, magnesium oxide, silica, etc. A preferable example of the inorganic powder is a titanium oxide (TiO₂). For instance, for a purpose that demands long-term outdoor weatherability (e.g. a protective sheet for use on exterior paint coats of large articles such as building materials, etc.), a titanium oxide can be preferably used as the inorganic weathering stabilizer.

The type of titanium oxide is not particularly limited. For instance, a titanium oxide of any crystalline type such as rutile, anatase, brookite, etc., can be used. In particular, rutile titanium oxide is preferable. A titanium oxide having coated particle surfaces may be used as well. The material to coat titanium oxide particles is not particularly limited. For instance, it can be an inorganic oxide such as silica, alumina, zinc oxide, etc. For instance, a highly weatherable titanium oxide whose particle surfaces are coated with Si—Al₂O₃, etc., can be preferably used.

The average particle diameter of the inorganic powder used as the inorganic weathering stabilizer is not particularly limited. For instance, from the standpoint of obtaining a good light-blocking effect, the average particle diameter of the inorganic powder is preferably 150 nm or larger, or more preferably 180 nm or larger. On the other hand, from the standpoint of the dispersibility, etc., the average particle diameter of the inorganic powder is preferably 500 nm or smaller, or more preferably 400 nm or smaller.

The inorganic weathering stabilizer content (amount added) in the inorganic weathering stabilizer-containing layer (layer W) is preferably 8% by weight or more of the layer W. A layer W having an inorganic weathering stabilizer content at or above the aforementioned lower limit can efficiently block UV rays and heat. Accordingly, a surface protective sheet substrate including such a layer W may exhibit sufficiently high weatherability. From the standpoint of obtaining a greater blocking effect, the inorganic weathering stabilizer content is more preferably 9% by weight or more of the layer W, or even more preferably 10% by weight or more.

The upper limit of inorganic weathering stabilizer content is not particularly limited. From the standpoint of weight reduction of the surface protective sheet, cost reduction and facile substrate molding, it is usually preferably 50% by weight or less of the layer W, or more preferably 30% by weight or less.

The surface protective sheet disclosed herein can be preferably made in an embodiment where the inorganic weathering stabilizer content in the layer W is 9% by weight or more, but 30% by weight or less, more preferably 10% by weight or more, but 25% by weight or less, or even more preferably 11% by weight or more, but 18% by weight or less, for instance, 12% by weight or more, but 15% by weight or less.

When the surface protective sheet substrate disclosed herein comprises two or more layers W, “the inorganic weathering stabilizer content in the layer W” refers to, unless otherwise informed, the proportion of the total weight of the inorganic weathering stabilizer contained in the layers W relative to the total weight of all layers W.

In a preferable embodiment of the surface protective sheet substrate disclosed herein, the inorganic weathering stabilizer-containing layer (layer W) has a thickness less than 40 p.m. When the substrate comprises two or more layers W, it is preferable that the overall thickness of the layers W is in this range.

The present inventors have found out that a portion less than 40 μm deep from the surface (plane of incidence) of an inorganic weathering stabilizer-containing layer to which an incoming light first strikes greatly contributes to increase the weatherability of the surface protective sheet substrate and a surface protective sheet using this substrate. In other words, it has been found out that a portion as deep as or deeper than 40 μm from the plane of incidence in the layer W makes a relatively small contribution to provide weatherability. The present invention has been made based on such findings, and by making the layer W less than 40 μm thick in the surface protective sheet substrate, the inorganic weathering stabilizer can be arranged away from areas contributing little to provide weatherability, thereby allowing for effective utilization of the inorganic weathering stabilizer contained in the substrate. In addition, with the layer W having a thickness of 10 μm or larger and the inorganic weathering stabilizer content being at or above the aforementioned lower limit (e.g. at or above 8% by weight of the layer W), a necessary and sufficient amount of the inorganic weathering stabilizer can be arranged in a place highly effective in providing weatherability. This can reduce the inorganic weathering stabilizer content relative to the entire substrate and also bring about great weatherability. In other words, such a substrate can bring about a reduction in the amount of inorganic weathering stabilizer added as well as high weatherability. Adding a smaller amount of inorganic weathering stabilizer is preferable from the standpoint of weight reduction, cost reduction, easier molding, etc. More preferable results can be obtained when the thickness of the layer W is 12 μm or larger, but 38 μm or smaller, or yet more preferably 15 μm or larger, but 35 μm or smaller, for instance, 17 μm or larger, but 30 μm or smaller.

In the art disclosed herein, the inorganic weathering stabilizer content per unit area of substrate is preferably 2.0 g/m² or greater (more preferably 2.4 g/m² or greater, or even more preferably 2.5 g/m² or greater). A surface protective sheet substrate may exhibit sufficiently high weatherability when the inorganic weathering stabilizer content per unit area of substrate is at or above the aforementioned lower limit. The inorganic weathering stabilizer content per unit area of substrate is preferably 3.3 g/m² or less (more preferably 3.0 g/m² or less, or yet more preferably 2.8 g/m² or less). A surface protective sheet substrate wherein the inorganic weathering stabilizer content is at or below the aforementioned upper limit is preferable from the standpoint of cost reduction, weight reduction, etc.

In an embodiment of the surface protective sheet substrate disclosed herein, the substrate may comprise, in addition to the inorganic weathering stabilizer-containing layer (layer W), an inorganic weathering stabilizer-free layer (or a layer NW hereinafter) which is a resin layer essentially free of an inorganic weathering stabilizer. Herein, that a layer NW is essentially free of an inorganic weathering stabilizer means that no inorganic weathering stabilizer is included, at least deliberately. In typical, it means that the inorganic weathering stabilizer content in the layer NW (when two or more layers NW are included, the inorganic weathering stabilizer content in each layer NW) is 0.5% by weight or less of the layer NW, more preferably 0.1% by weight or less, or even more preferably almost zero.

In a surface protective sheet substrate comprising a layer NW in addition to a layer W, the placement of the layer W and layer NW is not particularly limited. The layer NW may be placed, for instance, on a first surface of the layer W, on the second surface of the layer W, or on each of the first and second surfaces of the layer W. In a surface protective sheet substrate having two or more layers W, the layer NW can be placed in between the layers W. Herein, in a surface protective sheet having a PSA layer on a first surface of a surface protective sheet substrate comprising a layer W, the first surface of the layer W may be the surface closer to the PSA layer. The second surface of the layer W may be the surface on the opposite side of the layer W from the first surface.

The surface protective sheet substrate according to a preferable embodiment comprises, as the layer NW, a layer A which is a resin layer constituting the first surface of the substrate. A surface protective sheet substrate having such a constitution may exhibit higher weatherability when used in an embodiment of a surface protective sheet wherein a PSA layer is placed preferably on the surface of the layer A. For instance, one reason for this can be thought as follows: In a surface protective sheet in this embodiment, the layer A may be located via the PSA layer on the side to be placed against an adherend to be protected. On the other hand, in the surface protective sheet in the embodiment, a portion exposed to the heat of the outside air and UV rays to greater extent is on the opposite side from the PSA layer (on the back face side). Accordingly, the inorganic weathering stabilizer contributes more effectively to increase the weatherability when added to a layer further on the back face side than when added to the layer A. Thus, a surface protective sheet substrate wherein the layer A is essentially free of an inorganic weathering stabilizer is advantageous from the standpoint that it can ensure an inorganic weathering stabilizer content in a portion more effective in increasing the weatherability (a layer placed further on the back face side relative to the layer A). A surface protective sheet substrate comprising the layer A as the layer NW is advantageous also from the standpoint of the low contamination risk to an extruder and the like in the manufacturing process including molding and stretching steps for the substrate, etc.

The surface protective sheet substrate according to another preferable embodiment may comprise, as the layer NW, a layer B which is a resin layer constituting the second surface of the substrate. A surface protective sheet substrate having such a constitution is suitable, for instance, as a substrate for use in a surface protective sheet that comprises a PSA layer placed on the first surface of the substrate and is stored in a form of a surface protective sheet roll, being wound in a roll with the PSA layer surface in contact with the back face of the substrate. In a surface protective sheet having such a constitution, the first surface of the substrate, that is the surface on the side where the PSA layer is placed, can be either a layer W or a layer A. In a preferable substrate, the first surface is constituted with a layer A.

The surface protective sheet substrate disclosed herein may have a multi-layer structure formed of three or more layers. A preferable example of the surface protective sheet substrate having a multi-layer structure formed of three or more layers comprises a layer A which is a layer NW constituting the first surface of the substrate, a layer B which is a layer NW constituting the second surface of the substrate, and one, two or more layers W placed between the layer A and the layer B. A surface protective sheet substrate having such a constitution is preferable since it may have a lower potential for contamination of an extruder and the like in the manufacturing process including molding and stretching steps for the substrate, etc. More layer(s) NW may be placed between the layer W and the layer A, between the layer W and the layer B, or between any one, two or more pairs of layers W, respectively when two or more layers W are included.

In the following description, in regard to a surface protective sheet substrate having a multi-layer structure formed of two or more layers, a layer constituting the surface (first surface) on the side where a PSA layer is placed in a surface protective sheet using the substrate may be referred to as an “inner layer” while a layer constituting the opposite surface (the second surface) of the surface protective sheet substrate is sometimes referred to as a “surface layer.” With respect to a surface protective sheet substrate having a multi-layer structure formed of three or more layers, in a surface protective sheet using the substrate, a layer placed between an inner layer and a surface layer may be referred to as an “intermediate layer”.

### [Organic Weathering Stabilizer]

The surface protective sheet substrate disclosed herein may comprise an organic weathering stabilizer as an optional component. The term organic weathering stabilizer herein refers to an organic material capable of increasing the weatherability of the surface protective sheet substrate. The concept thereof generally encompasses additives called light stabilizer, UV absorber, and antioxidant. Examples of light stabilizer (radical scavenger) include stabilizers whose active ingredients are hindered amines (hindered amine light stabilizers or HALS). Examples of antioxidant include those containing benzophenones or sulfur compounds as active ingredients. Examples of UV absorber include those containing benzotriazoles as active ingredients.

From the standpoint of causing less contamination to an adherend, an organic weathering stabilizer having a weight average molecular weight Mw of 1.5×10³ or larger can be preferably used. Hereinafter, an organic weathering stabilizer having a Mw of 1.5×10³ or larger may be referred to as a high molecular weight organic weathering stabilizer.

As the organic weathering stabilizer, a stabilizer comprising a hindered amine as an active ingredient (HALS) can be preferably used. In particular, it is preferable to use a HALS having a Mw of 1.5×10³ or larger (typically 1.5×10³ to 50×10³, preferably 1.5×10³ to 10×10³, e.g. 1.5×10³ to 5×10³). Examples include a polymer of dimethyl succinate and 4-hydroxyl-2,2,6,6-tetramethyl-1-piperidyl ethanol (available from Ciba Specialty Chemicals Inc., trade name “TINUVIN® 622LD”), poly[{6-(1,1,3,3-tetrabutyl)amino-1,3,5-triazin-2,4-diyl} {(2,2,6,6-tetramethyl-4-piperidyl)imino}hexamethylene {(2,2,6,6-tetramethyl-4-piperidyl)imino}] (available from the same company, trade name “CHIMASSORB® 944FDL”), a polymer of dibutylamine-1,3,5-triazine-N,N′-bis(2,2,6,6-tetramethyl-4-piperidyl)-1,6-hexamethylenediamine and N-(2,2,6,6-tetramethyl-4-piperidyl)butylamine (available from the same company, trade name “CHIMASSORB® 2020FDL”), N,N′,N′,N′″-tetrakis-(4,6-bis-(butyl-(N-methyl-2,2,6,6-tetramethylpiperidine-4-yl)amino)-triazin-2-yl)-4,7-diazadecane-1,10-diamine and the like. These HALS can be used solely as one species or in combination of two or more species.

The organic weathering stabilizer content in the surface protective sheet substrate disclosed herein is not particularly limited. For instance, it can be 0.01% by weight or more, but 0.5% by weight or less of the entire substrate. Usually, it is preferably 0.01% by weight or more, but 0.25% by weight or less of the entire substrate, more preferably 0.03% by weight or more, but 0.21% by weight or less, even more preferably 0.04% by weight or more, but 0.2% by weight or less, or typically 0.05% by weight or more, but 0.18% by weight or less. For example, it is preferably 0.08% by weight or more, but 0.15% by weight or less. A surface protective sheet substrate having an organic weathering stabilizer content at or above the aforementioned lower limit may exhibit high weatherability. A surface protective sheet substrate having an organic weathering stabilizer content at or below the aforementioned upper limit may have a low potential for contamination of an adherend.

Although not particularly limited, when the surface protective sheet substrate is formed of a single layer (one layer), the organic weathering stabilizer content in the substrate may be, for instance, 0.14% by weight or less (preferably 0.13% by weight or less, more preferably 0.12% by weight or less, typically 0.1% by weight or less). In a surface protective sheet using the single-layer surface protective sheet substrate, this can preferably lead to a low contamination risk to an adherend subject to surface protection.

In the art disclosed herein, when the surface protective sheet substrate is formed of two layers, the organic weathering stabilizer content in the layer (inner layer) constituting the first surface of the substrate is not particularly limited. It is preferably 0.15% by weight or less, more preferably 0.10% by weight or less, or even more preferably 0.05% by weight or less. It is preferable that the inner layer is essentially free of an organic weathering stabilizer. For instance, the organic weathering stabilizer content in the inner layer may be almost 0, or 5.0×10-3% by weight or less (i.e. 50 ppm or less). When used in an embodiment of a surface protective sheet comprising a PSA layer preferably on an inner layer surface, a surface protective sheet substrate having such a constitution can bring about a surface protective sheet having a low potential for contamination of an adhered subject to surface protection. The inner layer may be a layer NW (i.e. a layer A) or a layer W.

Although not particularly limited, in a surface protective sheet substrate having such a two-layer structure, the organic weathering stabilizer content in the layer (surface layer) constituting the second surface of the substrate is preferably greater than the organic weathering stabilizer content in the inner layer. This allows prescribing the organic weathering stabilizer content in the entire substrate and reducing the organic weathering stabilizer content in the inner layer to further lower the contamination potential. When used in an embodiment of a surface protective sheet comprising a PSA layer preferably on an inner layer surface, a surface protective sheet substrate having such a constitution can bring about a surface protective sheet that combines great degree of weatherability and a low contamination potential. For example, the organic weathering stabilizer content in the inner layer can be equal to or less than 0.8 times the organic weathering stabilizer content in the surface layer. It is usually suitably 0.5 times or less, or preferably 0.1 times or less (e.g. 0.05 times or less). The surface layer may be a layer NW (i.e. a layer B) or a layer W.

In the art disclosed herein, when the surface protective sheet substrate has a multi-layer structure formed of three or more layers, the organic weathering stabilizer content in the layer (inner layer) constituting the first surface of the substrate is not particularly limited while it is preferably 0.15% by weight or less, more preferably 0.10% by weight or less, or even more preferably 0.05% by weight or less. It is preferable that the inner layer is essentially free of an organic weathering stabilizer. For instance, the organic weathering stabilizer content in the inner layer is preferably 0, or 5.0×10⁻³% by weight or less (i.e. 50 ppm or less). A surface protective sheet substrate having such a constitution can make a surface protective sheet that has a low potential for contamination of an adherend subject to surface protection.

The inner layer can be a layer NW (i.e. a layer A) or a layer W. In a preferable embodiment, the inner layer is a layer A.

In the art disclosed herein, when the surface protective sheet substrate has a multi-layer structure formed of three or more layers, the organic weathering stabilizer content in the layer (surface layer) constituting the second surface of the substrate is not particularly limited while it is preferably 0.5% by weight or less, more preferably 0.3% by weight or less, or even more preferably 0.1% by weight or less. In a surface protective sheet substrate having a multi-layer structure with three or more layers, it is preferable that the surface layer is essentially free of an organic weathering stabilizer. For instance, the organic weathering stabilizer content in the surface layer is preferably almost 0, or 5.0×10⁻³% by weight or less (i.e. 50 ppm or less). A surface protective sheet substrate having such a constitution may have a low potential for contamination of an adherend when used in an embodiment of a surface protective sheet that comprises a PSA layer preferably on an inner layer surface and is wound in a roll prior to use.

In other words, generally, when a surface protective sheet prior to use is formed in a roll wherein the PSA layer surface is in contact with the back face of the substrate, the organic weathering stabilizer may transfer from the back face of the substrate to the PSA layer in contact with the substrate, and the organic weathering stabilizer transferred to the PSA layer may further contaminate the adherend subject to surface protection. Thus, when the surface layer is essentially free of the organic weathering stabilizer, the organic weathering stabilizer is inhibited from transferring to the PSA layer placed on the inner layer side surface, and thus contamination of the adhered can be inhibited.

The surface layer can be a layer NW (i.e. a layer B) or a layer W. In a preferable embodiment, the surface layer is a layer B.

The amount and weight average molecular weight of an organic weathering stabilizer contained in a substrate or a resin layer constituting the substrate can be determined, for instance, by extracting the substrate or resin layer with a suitable organic solvent and analyzing the extract.

To the surface protective sheet substrate disclosed herein, a suitable component (additive) allowable for inclusion in the substrate can be added as necessary. Examples of such additives include a slip agent, anti-blocking agent, etc. These additives can be used solely as one species or in combination of two or more species. For instance, the amount of additive(s) added can be selected to be about the same as a usual amount used in the field of resin sheets for use as substrates for surface protective sheets (e.g. paint protective sheets, etc.) and the like. For a multi-layer substrate, the presence of these additives and their amounts added if any can be the same or different among the respective layers.

The overall thickness of the surface protective sheet substrate disclosed herein is not particularly limited and can be suitably selected in accordance with the purpose. It is usually suitable to use a substrate having an overall thickness of about 300 μm or smaller (e.g. 10 μm or larger, but 100 μm or smaller). In a preferable embodiment of the surface protective sheet substrate disclosed herein, the substrate has an overall thickness of 15 μm or larger, but 70 μm or smaller, or more preferably 30 μm or larger, but smaller than 60 μm, typically 30 μm or larger, but 50 μm or smaller. A surface protective sheet formed with a substrate having such an overall thickness is preferable from the standpoint of producing a thinner sheet while ensuring its PSA layer to have a necessary thickness.

In an embodiment of the surface protective sheet substrate disclosed herein, the thickness of the layer A can be, for instance, about 3 μm or larger, or preferably about 5 μm or larger. When the layer A's thickness is excessively small, it may be difficult to form the layer A as a uniform, continuous layer. Accordingly, for instance, in a constitution where a layer W is placed adjacent to a layer A, it may be difficult to produce a substrate with the layer A evenly covering the surface of the layer W, and due to inconsistency in the substrate manufacturing, etc., some holes may be formed in the layer A, exposing the layer W to the PSA layer side surface. When providing the surface protective sheet in an embodiment where an organic weathering stabilizer is included in the layer W, but not in the layer A while the PSA layer is placed on the surface of the layer A, from the standpoint of lowering the contamination potential, it is particularly meaningful that the layer A has a thickness of 3 μm or larger.

The substrate can be produced by suitably employing a heretofore known, general resin sheet (film) formation method. For example, using a molding material comprising the resin component, additives added as necessary and the like, a sheet can be formed by a molding method such as extrusion (e.g. a T-die method), an inflation method, etc. As the method for producing a multi-layer substrate, a general multi-layer extrusion method can be preferably used.

### [Constitution of Surface Protective Sheet]

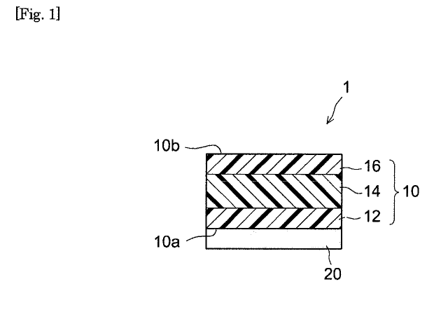

The surface protective sheet substrate disclosed herein can be preferably used in an embodiment of a surface protective sheet comprising the substrate and a PSA layer placed on a first surface thereof. FIG. 1 schematically illustrates a preferable embodiment of such a surface protective sheet. Surface protective sheet 1 has a PSA layer 20 on a first surface (PSA layer side surface) 10a of a surface protective sheet substrate 10.

Surface protective sheet substrate 10 comprises an inorganic weathering stabilizer-containing layer (layer W) 14. On a first surface of inorganic weathering stabilizer-containing layer (layer W) 14, there is placed a layer A (inner layer) 12 that is an inorganic weathering stabilizer-free layer (layer NW) and constitutes the PSA layer side surface 10a of substrate 10. On the second surface side (back face side) of inorganic weathering stabilizer-containing layer (layer W) 14, there is placed a layer B (surface layer) 16 that is an inorganic weathering stabilizer-free layer (layer NW) and constitutes the back face 10b of substrate 10. Although FIG. 1 exemplifies surface protective sheet 1 having surface protective sheet substrate 10 which includes one layer W 14 and has a three-layer structure as a whole, there can be included two or more layers W 14. It may further have a layer NW different from the layer A 12 or layer B 14.

When surface protective sheet 1 is used, PSA layer 20 is adhered to an adherend (article to be protected). Surface protective sheet 1 prior to use (i.e. before adhered to the adherend) may have a form where the surface (adhesive face) of PSA layer 20 is protected with a release liner (not shown in the drawing) having a release face at least on the PSA layer side. Alternatively, it may have a form where the second surface (back face) 10b of substrate 10 is a release face and the surface protective sheet 1 is wound in a roll so that the back face 10b contacts and protects the surface of PSA layer 20.

In surface protective sheet substrate 10 shown in FIG. 1, the face 10a on the PSA layer side can be pre-subjected to a surface treatment such as an acid treatment, corona discharge treatment, UV irradiation treatment, plasma treatment, primer coating, etc. The back face 10b of substrate 10 can be pre-subjected as necessary to a release treatment (e.g. a treatment where a general silicone-based, long chain alkyl-based, fluorine-based or similar release agent is provided in a thin layer, typically about 0.01 μm to 1.0 μm thick). Such a release treatment can bring about effects such as easy unwinding of surface protective sheet 10 wound in a roll, and so on.

### [PSA Layer]

The PSA layer preferably included in the surface protective sheet disclosed herein may comprise, as its base polymer(s), one, two or more species among various polymers commonly known in the PSA field, such as a rubber-based polymer, acrylic polymer, polyester-based polymer, urethane-based polymer, polyether-based polymer, silicone-based polymer, polyamide-based polymer, fluorine-based polymer, etc.

In this description, the term “base polymer” of a PSA refers to the primary component among rubbery polymers contained in the PSA. The term rubbery polymer refers to a polymer that exhibits rubber elasticity in a room temperature range. In this description, the term “primary component” refers to a component accounting for more than 50% by weight of the content unless otherwise indicated.

In a preferable embodiment, the PSA layer is a rubberbased PSA layer formed from a PSA composition comprising a rubberbased polymer as a base polymer (the primary component among polymers). Examples of the base polymer in a rubberbased PSA include various rubber-based polymers such as a natural rubber; styrene-butadiene rubber (SBR); polyisoprene; butyl rubbers such as a regular butyl rubber, chlorinated butyl rubber, brominated butyl rubber, etc.; isobutylene-based polymers such as a polyisobutylene, isoprene-isobutylene copolymer or a modified product thereof, etc.; an A-B-A block copolymer rubber and a hydrogenation product thereof, such as a styrene-butadiene-styrene block copolymer rubber (SBS), styrene-isoprene-styrene block copolymer rubber (SIS), styrene-vinylisoprene-styrene block copolymer rubber (SVIS), styrene-ethylene-butylene-styrene block copolymer rubber (SEBS) which is a hydrogenation product of SBS, styrene-ethylene-propylene-styrene block copolymer rubber (SEPS) which is a hydrogenation product of SIS; and the like.

The art disclosed herein can be preferably applied to a surface protective sheet comprising a PSA layer formed of a non-crosslink-type PSA. Examples of the non-crosslink-type PSA include a PSA comprising an ABA-type block copolymer rubber or its hydrogenation product as the base polymer, a PSA comprising an isobutylene-based polymer as the base polymer, and the like. Among these, a preferable PSA layer is constituted with a non-crosslink-type PSA (a polyisobutylene-based PSA) formed from a PSA composition comprising an isobutylene-based polymer as the base polymer. For instance, when the adherend is an article comprising a paint layer such as a painted steel plate, etc., since a polyisobutylene-based PSA has a solubility parameter value (SP value) that is largely different from that of the paint layer, transfer of a substance is unlikely to occur between the two and the adherend surface is unsusceptible to the occurrence of adhesion marks. Such a PSA layer is highly elastic and is preferable as a PSA (removable PSA) for use in a PSA sheet used in an embodiment where it is eventually removed, such as a surface protective sheet.

The isobutylene-based polymer may be an isobutylene homopolymer (homoisobutylene) or a copolymer based on isobutylene as a primary monomer. Examples of the copolymer include a copolymer of isobutylene and normal butylene, copolymer of isobutylene and isoprene (regular butyl rubber, chlorinated butyl rubber, brominated butyl rubber, partially crosslinked butyl rubber, etc.), vulcanized products or modified products of these (e.g. products modified with a functional group such as hydroxyl group, carboxyl group, amino group, epoxy group, etc.), and the like. From the standpoint of the stability of adhesive strength (e.g., unsusceptibility to an excessive increase in the adhesive strength due to aging or a thermal history), preferably usable isobutylene-based polymers include a homoisobutylene and an isobutylene-normal butylene copolymer. In particular, a homoisobutylene is preferable.

The molecular weight of such an isobutylene-based polymer is not particularly limited. For instance, an isobutylene-based polymer having a weight average molecular weight (Mw) of about 1×10⁴ to 150×10⁴ can be suitably selected and used. Two or more isobutylene-based polymers having individually different Mw values may be used in combination. As a whole, the isobutylene-based polymer for use has a Mw value in a range of preferably about 10×10⁴ to 150×10⁴ (more preferably about 30×10⁴ to 100×10⁴).

The isobutylene-based polymer may be an isobutylene-based polymer (a masticated product) obtained from an isobutylene-based polymer with a higher molecular weight via a mastication process to lower the molecular weight (preferably to lower the weight average molecular weight to the preferable range described above). The mastication process can be preferably carried out so as to obtain an isobutylene-based polymer having a Mw value equal to approximately 10% to 80% of the pre-mastication value. It is also preferable to carry out the process so as to obtain an isobutylene-based polymer having a number average molecular weight (Mn) of about 10×10⁴ to 40×10⁴. Such a mastication process can be performed based on the contents of Japanese Patent No. 3878700.

The polyisobutylene-based PSA may comprise, as its base polymer(s), one, two or more species selected from these isobutylene-based polymers. In addition to the base polymer, the polyisobutylene-based PSA may comprise, as a secondary component, a non-polyisobutylene-based polymer. Examples of such a polymer include a poly(meth)acrylic acid ester, polybutadiene, polystyrene, polyisoprene, polyurethane, polyacrylonitrile, polyamide, etc. The non-polyisobutylene-based polymer content is usually preferably 10% by weight or less of the total polymer content in the polyisobutylene-based PSA. The PSA may be essentially free of a non-polyisobutylene-based polymer.

The PSA preferably used in the surface protective sheet disclosed herein may contain as necessary suitable components (additives) allowable for inclusion in the PSA. Examples of such additives include a softener, tackifier, release agent, etc. Other examples include an inorganic weathering stabilizer such as a pigment, filler, etc.; and an organic weathering stabilizer such as a light stabilizer (radical scavenger), UV absorber, antioxidant, etc. These additives can be used solely or in combination of two or more species. The amount of additive(s) added can be, for instance, about the same as a usual amount used in the field of PSA for use in surface protective sheets.

Examples of a preferably usable tackifier include an alkylphenol resin, terpene phenol resin, epoxy-based resin, coumarone-indene resin, rosin-based resin, terpene-based resin, alkyd resin, hydrogenation products thereof, and the like. When a tackifier is used, its amount added can be, for instance, about 0.1 to 50 parts by weight relative to 100 parts by weight of the base polymer. It is usually preferable that the amount added relative to 100 parts by weight of the base polymer is 0.1 to 5 parts by weight. Alternatively, the PSA may have a composition essentially free of a tackifier.

Examples of softener include a rubber-based material having a low molecular weight, process oil (typically a paraffin-based oil), petroleum-based softener, epoxy-based compound, and the like. Examples of pigments and fillers include inorganic powders such as titanium oxide, zinc oxide, calcium oxide, magnesium oxide, silica and the like. Examples of a release agent include silicone-based release agents, paraffin-based release agents, polyethylene wax, acrylic polymers and the like. When using a release agent, its amount can be, for instance, about 0.01 to 5 parts by weight relative to 100 parts by weight of the base polymer. Alternatively, the PSA may have a composition essentially free of such a release agent. As the light stabilizer, UV absorber and antioxidant, the same kinds as those for the substrate and the like can be used.

In the art disclosed herein, the thickness of the PSA layer is not particularly limited and can be suitably selected in accordance with the purpose. It is usually suitably about 100 μm or smaller (e.g. about 2 μm to about 100 μm), preferably about 3 μm to about 30 μm, or more preferably about 5 μm to about 20 μm.

The PSA layer can be formed based on a method for forming PSA layers known in the PSA sheet field. For instance, can be preferably employed a method (direct method) where a PSA layer is formed by obtaining (by production, purchase, etc.) a PSA composition in which PSA layer-forming materials including a polymer and additive(s) added as necessary are dissolved or dispersed in a suitable solvent, directly providing (typically applying) the composition to a substrate and allowing the composition to dry. Alternatively, can be employed a method (transfer method) where a PSA layer is transferred to a substrate, with the PSA layer having being pre-formed on a highly releasable surface (e.g., a release liner surface, the back face of a substrate that has been processed with a release treatment, etc.) by applying the PSA composition thereto and allowing the composition to dry. While the PSA layer is typically formed to have a continuous phase, it can be formed to have a regular or random pattern of dots, stripes, etc., depending on the purpose and intended use.

The surface protective sheet disclosed herein may exhibit excellent weatherability in a weatherability test conducted under the conditions described later in the worked examples. In particular, the surface protective sheet may have a fracture strength of 15 N/25 mm or greater even after left standing for 1000 hours in an accelerated weathering environment under the conditions prescribed in the worked examples. The surface protective sheet may exhibit a peel strength to SUS 430BA plate or black-painted plate of less than 8 N/25 mm even after left standing for 1000 hours similarly in the accelerated weathering environment under the prescribed conditions. Such a surface protective sheet exhibits excellent weatherability. Accordingly, it can be preferably used, for instance, as a surface protective sheet used in a state where it is adhered on an article (e.g. a building material, etc.) that is to be stored for a prolonged period in an environment exposed to high temperatures (e.g. 30° C. to 60° C.) and UV radiation, such as in the outdoors in summer, etc.

The art disclosed herein can also provide a surface protective sheet that has a low contamination potential equivalent to the level M (moderate) or level L (low) in the contamination test. In other words, the surface protective sheet disclosed herein may have a low potential for contamination of a paint layer. Such a surface protective sheet is preferable as a surface protective sheet which, for use, is adhered to an article having a paint layer (e.g. a painted steel plate, etc.).

### Examples

Several worked examples relating to the present invention are described below, but the present invention is not intended to be limited to these examples. In the description below, “parts” and “%” are based on weight unless otherwise specified.

The following starting materials were used for fabricating surface protective sheets in the respective examples below.

H-PP: homopolypropylene (available from Japan Polypropylene Corporation, trade name “NOVATEC PP FY4”, MFR=5.0)

B-PP: block polypropylene (available from Japan Polypropylene Corporation, trade name “NOVATEC PP BC8”, MFR=1.8)

LLDPE: linear low density polyethylene (available from Japan Polyethylene Corporation, trade name “KERNEL KF380”; density d=0.925 g/cm³)

TiO₂: Si—Al₂O₃-coated rutile titanium dioxide (available from Ishihara Sangyo Kaisha, Ltd., trade name “TIPAQUE CR-95”)

HALS: organic weathering stabilizer (available from Nihon Ciba-Geigy K K., trade name “CHIMASSORB® 944FDL”)

### [Fabrication of Surface Protective Sheet Substrates]

Mixtures of starting materials at weight ratios shown in Table 1 and Table 2 below were melted and kneaded with a three-layer co-extrusion T-die film forming machine to form films so that the respective layers had thickness values as shown in Table 1 and Table 2, whereby surface protective sheet substrates were fabricated. The thicknesses of the surface layer, intermediate layer and inner layer constituting the substrate according to each example were determined by electron microscope observations. The compositions of the surface protective sheet substrates according to Examples 1 to 18 are summarized in Table 1 and Table 2. Table 3 and Table 4 show the thickness of the titanium oxide-containing layers of the surface protective sheets according to Examples 1 to 18 (when the substrate has two or more titanium oxide-containing layers, the total thickness of these titanium oxide-containing layers), the titanium oxide concentrations in the titanium oxide-containing layers, the titanium oxide concentrations in the entire substrates, the titanium oxide contents per unit area of substrate and the HALS concentrations in the entire substrates.

### [Fabrication of PSA Layers]

100 parts of a polyisobutylene and 0.4 part of a p-tert-octylphenol resin (available from Sumitomo Durez Co., Ltd.; trade name “DUREZ 19900”) as a tackifier were dissolved in an organic solvent to prepare a PSA solution. As the polyisobutylene, trade names “OPPANOL B-80” and “OPPANOL B-12SFN” available from BASF Corporation were used at a weight ratio of 75:25. The PSA solution was applied to the inner layer side surface of the surface protective sheet substrate obtained above according to each example and allowed to dry to form a 10 μm thick PSA layer. In such a manner, surface protective sheets according to Examples 1 to 18 were fabricated.

TABLE 1

| Example | | 1 | 2 | 3 | 4 | 5 | 6 | 7 | 8 | 9 | 10 |
|---|---|---|---|---|---|---|---|---|---|---|---|
| Surface layer (parts) | TiO₂ | 8 | 0 | 0 | 4 | 0 | 0 | 0 | 0 | 0 | 0 |
| H-PP/B-PP/LLDPE | HALS | 0.1 | 0 | 0 | 0 | 0 | 0.1 | 0.2 | 0.2 | 0.4 | 0 |
| 50/20/30 | | | | | | | | | | | |
| Intermediate layer (parts) | TiO₂ | 12 | 12 | 15 | 13 | 13 | 13 | 13 | 13 | 13 | 10 |
| H-PP/B-PP/LLDPE | HALS | 0.2 | 0.2 | 0.2 | 0.2 | 0.2 | 0.2 | 0.2 | 0.3 | 0.4 | 0.2 |
| 20/0/70 | | | | | | | | | | | |
| Inner layer (parts) | TiO₂ | 0 | 0 | 0 | 0 | 0 | 0 | 0 | 0 | 0 | 0 |
| H-PP/B-PP/LLDPE | HALS | 0 | 0 | 0 | 0 | 0 | 0 | 0 | 0 | 0 | 0 |
| 50/20/30 | | | | | | | | | | | |
| Layer thickness (μm) | Surface | 10 | 10 | 10 | 10 | 10 | 10 | 10 | 10 | 10 | 15 |
| | Intermediate | 20 | 20 | 20 | 20 | 20 | 20 | 20 | 20 | 20 | 30 |
| | Inner | 10 | 10 | 10 | 10 | 10 | 10 | 10 | 10 | 10 | 15 |

| | | | | | | | | | | |
|---|---|---|---|---|---|---|---|---|---|---|
| Overall thickness of substrate (μm) | 40 | 40 | 40 | 40 | 40 | 40 | 40 | 40 | 40 | 60 |

TABLE 2

| Example | | 11 | 12 | 13 | 14 | 15 | 16 | 17 | 18 |
|---|---|---|---|---|---|---|---|---|---|
| Surface layer (parts) | TiO₂ | 0 | 0 | 8 | 0 | 8 | 8 | 0 | 0 |
| H-PP/B-PP/LLDPE | HALS | 0 | 0 | 0.2 | 0.2 | 0.2 | 0.1 | 0 | 0.2 |
| 50/20/30 | | | | | | | | | |
| Intermediate layer (parts) | TiO₂ | 10 | 15 | 15 | 25 | 10 | 12 | 10 | 15 |
| H-PP/B-PP/LLDPE | HALS | 0.2 | 0.2 | 0.2 | 0.2 | 0.2 | 0.2 | 0.2 | 0.2 |
| 20/0/70 | | | | | | | | | |
| Inner layer (parts) | TiO₂ | 0 | 0 | 0 | 0 | 6 | 4 | 0 | 0 |
| H-PP/B-PP/LLDPE | HALS | 0 | 0 | 0 | 0 | 0 | 0.1 | 0 | 0 |
| 50/20/30 | | | | | | | | | |
| Layer thickness (μm) | Surface | 15 | 7.5 | 10 | 10 | 10 | 10 | 10 | 5 |
| | Intermediate | 35 | 15 | 10 | 10 | 10 | 20 | 20 | 10 |
| | Inner | 15 | 7.5 | 10 | 10 | 10 | 10 | 10 | 5 |

| | | | | | | | | |
|---|---|---|---|---|---|---|---|---|
| Overall thickness of substrate (μm) | 65 | 30 | 30 | 30 | 30 | 40 | 40 | 20 |

### [Weatherability Test I: Measurement of Fracture Strength]

Each surface protective sheet was cut to prepare test pieces having a rectangular shape (25 mm wide, 100 mm long). For this, the length direction of the test piece corresponded to the length direction (or “MD”; the same applies hereinafter) of the surface protective sheet. With Sunshine Weather Meter (available from Suga Test Instruments, Co., Ltd., model name “S80H”, light source: Sunshine Carbon Arc lamp) as the weatherability tester, the test pieces (surface protective sheets) were subjected to cycles of accelerated weathering exposure at a black panel temperature of 63° C., at a humidity of 50% RH, and at an irradiance of 255 W/m² (wavelength: 300 nm to 700 nm) for 120 minutes (102 minutes without rain and 18 minutes with rain) per cycle for 1000 hours. The accelerated weathering exposure was carried out based on JIS B 7753.

The test pieces after the accelerated weathering exposure were stored in an environment at 23° C., 50% RH for 6 hours and then subjected to measurements of fracture strength in the length direction (MD). More specifically, based on JIS K 7127, in an environment at 23° C., 50% RH, the test pieces were stretched to fracture at a tensile speed of 300 mm/min with a precision universal tester (available from Shimadzu Corporation, model name “AUTOGRAPH AG-IS”), and the maximum tensile load (unit: N/25 mm) during this procedure was measured. With respect to the surface protective sheet according to each example, three test pieces were used for the measurement and their average value was recorded as the fracture strength after accelerated weathering exposure.

Based on the fracture strength after accelerated weathering, the weatherability was evaluated in the following three grades: E (excellent) when the fracture strength was 25 N/25 mm or greater; G (good) when 15 N/25 mm or greater, but less than 25 N/25 mm; and P (poor) when less than 15 N/25 mm. When the surface protective sheets prior to the accelerated weathering exposure were subjected to the same measurement, the fracture strength values of the respective examples were all approximately 50 N/25 mm.

### [Weathering Test II: Measurement of Peel Strength (Adhesive Strength)]

The surface protective sheets were cut to prepare test pieces having a rectangular shape (25 mm wide, 100 mm long). For this, the length direction of the test piece corresponded to the MD of the surface protective sheet. As the adherend, a stainless steel plate (SUS 430BA plate) and a black painted plate (available from Nippon Testpanel Co., Ltd.) were obtained. Herein, the black painted plate is a stainless steel plate having a layer of a black paint coating (available from Kansai Paint Co., Ltd.; trade name “RETAN PG HYBRID ECO DEEP BLACK”) and further having a clear coat layer formed of a clear coating (available from Kansai Paint Co., Ltd.; trade name “RETAN PG ECO HS CLEAR”) applied on top of the black paint coating.

The test pieces (surface protective sheets) were press-bonded over their adhesive faces to the surface of the SUS plate and the black painted plate to prepare measurement samples, respectively. The press-bonding was performed by moving a 2 kg roller back and forth once.

These measurement samples were placed in the Sunshine Weather Meter (available from Suga Test Instruments, Co., Ltd., model name “S80H”, light source: Sunshine Carbon Arc lamp) and subjected to cycles of accelerated weathering exposure for 1000 hours under the same conditions as the aforementioned weathering test I.

The measurement samples after the accelerated weathering exposure were stored in an environment at 23° C., 50% RH for 6 hours. Subsequently, in the same environment, based on JIS Z 0237, using a universal tensile tester, the peel strength (unit: N/25 mm) was measured at a tensile speed of 30 m/min at a peel angle of 180°. With respect to the surface protective sheet according to each example, three test pieces were subjected to the measurement and their average value was recorded as the peel strength after accelerated weathering exposure.

Based on the peel strength to SUS plate and peel strength to black painted plate after accelerated weathering exposure measured in this test, the peel strength stability of the surface protective sheets relative to the accelerated weathering exposure test was evaluated in the following three grades: E (excellent) when the peel strength to each adherend was less than 5 N/25 mm; G (good) when less than 8 N/25 mm to each adherend while 5 N/25 mm or greater, but less than 8 N/25 mm to at least one of the adherends; and P (poor) when 8 N/25 mm or greater to at least one of the adherends. When the surface protective sheets prior to the accelerated weathering exposure were subjected to the same measurement, the peel strength values of the respective examples were all approximately 3 N/25 mm.

### [Contamination Test]

Each surface protective sheet was press-bonded over its adhesive face to the same black painted plate (available from Nippon Testpanel Co., Ltd.) as above to prepare a measurement sample. The press-bonding was carried out by moving a 2 kg roller back and forth once. The measurement sample was stored in an environment at 70° C. for one week. Subsequently, from the black painted plate, the surface protective sheet was removed by hand of a tester at a tensile speed of about 0.1 m/min at a peel angle of 90°. After the removal of the surface protective sheet, the surface of the black painted plate was visually inspected for the presence of any deposit (i.e. the presence of contamination) and graded in the following three levels: L (low) when no deposit was observed; M (moderate) when some deposit was observed, but was removable with cloth; and H (high) when some deposit was observed and was irremovable with cloth.

With respect to the surface protective sheets according to Examples 1 to 18, the results of the respective tests are shown in Table 3 and Table 4.

TABLE 3

| Example | 1 | 2 | 3 | 4 | 5 | 6 | 7 | 8 | 9 | 10 |
|---|---|---|---|---|---|---|---|---|---|---|
| Thickness of TiO₂- | 30 | 20 | 20 | 30 | 20 | 20 | 20 | 20 | 20 | 30 |
| containing layer (μm) | | | | | | | | | | |
| TiO₂ concentration in | 10.7 | 12 | 15 | 10 | 13 | 13 | 13 | 13 | 13 | 10 |
| TiO₂-containing layer | | | | | | | | | | |
| (wt %) | | | | | | | | | | |
| TiO₂ concentration in | 8.0 | 6.0 | 7.5 | 7.5 | 6.5 | 6.5 | 6.5 | 6.5 | 6.5 | 5.0 |
| entire substrate (wt %) | | | | | | | | | | |
| TiO₂ content per unit | 3.0 | 2.3 | 2.9 | 2.9 | 2.5 | 2.5 | 2.5 | 2.5 | 2.5 | 2.9 |
| area of substrate | | | | | | | | | | |
| (g/m²) | | | | | | | | | | |
| HALS concentration in | 0.125 | 0.1 | 0.1 | 0.1 | 0.1 | 0.125 | 0.15 | 0.2 | 0.3 | 0.1 |
| entire substrate (wt %) | | | | | | | | | | |
| Fracture strength after | E | G | E | G | G | E | E | E | E | E |
| accelerated weathering | | | | | | | | | | |
| exposure | | | | | | | | | | |
| Peel strength after | E | G | E | G | G | E | E | E | E | G |
| accelerated weathering | | | | | | | | | | |
| exposure | | | | | | | | | | |
| Contamination risk | L | L | L | L | L | L | L | L | M | L |

TABLE 4

| Example | 11 | 12 | 13 | 14 | 15 | 16 | 17 | 18 |
|---|---|---|---|---|---|---|---|---|
| Thickness of TiO₂- | 35 | 15 | 20 | 10 | 30 | 40 | 20 | 10 |
| containing layer (μm) | | | | | | | | |
| TiO₂ concentration in | 10 | 15 | 11.6 | 24.9 | 8 | 9 | 10 | 15 |
| TiO₂-containing layer | | | | | | | | |
| (wt %) | | | | | | | | |
| TiO₂ concentration in | 5.4 | 7.5 | 7.7 | 8.3 | 8.0 | 9.0 | 5.0 | 7.5 |
| entire substrate (wt %) | | | | | | | | |
| TiO₂ content per unit | 3.3 | 2.1 | 2.2 | 2.4 | 2.3 | 3.4 | 1.9 | 1.4 |
| area of substrate | | | | | | | | |
| (g/m²) | | | | | | | | |
| HALS concentration in | 0.1 | 0.1 | 0.15 | 0.15 | 0.15 | 0.15 | 0.1 | 0.15 |
| entire substrate (wt %) | | | | | | | | |
| Fracture strength after | E | E | E | E | G | E | P | P |
| accelerated weathering | | | | | | | | |
| exposure | | | | | | | | |
| Peel strength after | G | E | E | E | G | E | P | P |
| accelerated weathering | | | | | | | | |
| exposure | | | | | | | | |
| Contamination risk | L | L | L | L | L | H | L | L |

As shown in Tables 3 and 4, Examples 1 to 16 with 2.1 g/m² or greater titanium oxide contents per unit area of substrate evidently had excellent weatherability as indicated by their high fracture strength of 15 N/25 mm or greater (preferably 25 N/25 mm or greater) and low peel strength less than 8 N/25 mm (preferably less than 5 N/25 mm) even after the 1000 hours of accelerated weathering exposure by the Sunshine Weather Meter. As compared to the surface protective sheet according to Example 9, the surface protective sheets according to Examples 1 to 8 and 10 to 15 were evidently endowed with lower contamination potentials against an adherend (black painted plate), with each including no HALS in the inner layer and having a less than 0.3% by weight (i.e. less than 3000 ppm) HALS content in the entire substrate. In terms of the contamination risk, the surface protective sheet substrate according to Example 16 was inferior to the surface protective sheet substrates according to the other examples. The surface protective sheet substrates according to Example 17 and Example 18 exhibited tendencies toward poorer weatherability.

Although specific embodiments of the present invention have been described in detail above, these are merely for illustrations and do not limit the scope of the claims. The art according to the claims includes various modifications and changes made to the specific embodiments illustrated above.

What is claimed is:

1. A surface protective sheet substrate, wherein
the substrate is a resin film comprising a polyolefin resin which accounts for more than 50% by weight of the entire substrate,
the substrate comprises an inorganic weathering stabilizer-containing layer which comprises an inorganic weathering stabilizer,
the inorganic weathering stabilizer-containing layer has a thickness of 10 μm or larger, but smaller than 40 μm,
the inorganic weathering stabilizer content accounts for 8% by weight or more of the inorganic weathering stabilizer-containing layer, and
the inorganic weathering stabilizer content per unit area of substrate is 2.0 g/m² or greater.

2. The surface protective sheet substrate according to claim 1, wherein the inorganic weathering stabilizer comprises a titanium oxide.

3. The surface protective sheet substrate according to claim 1, wherein the inorganic weathering stabilizer content accounts for 9% by weight or less of the entire substrate.

4. The surface protective sheet substrate according to claim 1, wherein the substrate further comprises a layer A that is a resin layer constituting a first surface of the substrate and is essentially free of an inorganic weathering stabilizer.

5. The surface protective sheet substrate according to claim 4, wherein the substrate comprises an organic weathering stabilizer at 0.25% by weight or less of the entire substrate and the layer A is an organic weathering stabilizer-free layer which is essentially free of the organic weathering stabilizer.

6. The surface protective sheet substrate according to claim 4, wherein the substrate further comprises a layer B that is a resin layer constituting a second surface of the substrate and is essentially free of an inorganic weathering stabilizer.

7. The surface protective sheet substrate according to claim 6, wherein the layer B is an organic weathering stabilizer-free layer which is essentially free of the organic weathering stabilizer.

8. The surface protective sheet substrate according to claim 1, wherein the substrate has an overall thickness smaller than 60 μm.

9. A surface protective sheet comprising the surface protective sheet substrate according to claim 1 and a pressure-sensitive adhesive layer placed on a first surface of the surface protective sheet substrate.

10. The surface protective sheet substrate according to claim 2, wherein the inorganic weathering stabilizer content accounts for 9% by weight or less of the entire substrate.

11. The surface protective sheet substrate according to claim 2, wherein the substrate further comprises a layer A that is a resin layer constituting a first surface of the substrate and is essentially free of an inorganic weathering stabilizer.

12. The surface protective sheet substrate according to claim 2, wherein the substrate has an overall thickness smaller than 60 μm.

13. A surface protective sheet comprising the surface protective sheet substrate according to claim 2 and a pressure-sensitive adhesive layer placed on a first surface of the surface protective sheet substrate.

14. The surface protective sheet substrate according to claim 3, wherein the substrate further comprises a layer A that is a resin layer constituting a first surface of the substrate and is essentially free of an inorganic weathering stabilizer.

15. The surface protective sheet substrate according to claim 3, wherein the substrate has an overall thickness smaller than 60 μm.

16. A surface protective sheet comprising the surface protective sheet substrate according to claim 3 and a pressure-sensitive adhesive layer placed on a first surface of the surface protective sheet substrate.

17. The surface protective sheet substrate according to claim 4, wherein the substrate has an overall thickness smaller than 60 μm.

18. A surface protective sheet comprising the surface protective sheet substrate according to claim 4 and a pressure-sensitive adhesive layer placed on a first surface of the surface protective sheet substrate.

19. The surface protective sheet substrate according to claim 5, wherein the substrate further comprises a layer B that is a resin layer constituting a second surface of the substrate and is essentially free of an inorganic weathering stabilizer.

20. The surface protective sheet substrate according to claim 5, wherein the substrate has an overall thickness smaller than 60 μm.
